(19) United States
(12) Patent Application Publication
(10) Pub. No.: US 2004/0017973 A1
(43) Pub. Date: Jan. 29, 2004

(54) Wavelength filter, variable wavelength filter, and optical device

(75) Inventor: Hirokazu Aritake, Kawasaki (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: Fujitsu Media Devices Limited and FUJITSU LIMITED

(21) Appl. No.: 10/617,753

(22) Filed: Jul. 14, 2003

(30) Foreign Application Priority Data
Jul. 24, 2002 (JP) 2002-215263

(51) Int. Cl. G02B 6/26

(52) U.S. Cl. 385/40; 385/27

(57) ABSTRACT

A wavelength filter includes lattice structures that are arranged at predetermined intervals in the direction of an optical axis. Each of the lattice structures has regions of two different refractive indices that are alternately arranged.

### BACKGROUND OF THE INVENTION

1. Field of the Invention

The present invention generally relates to a wavelength filter, a variable wavelength filter, and an optical device that includes the wavelength filter or the variable wavelength filter, and more particularly, to a reflection wavelength filter, a variable wavelength filter, and an optical device that includes the wavelength filter or the variable wavelength filter.

2. Description of the Related Art

FIGS. 1A through 1D illustrate a conventional wavelength filter that will be hereinafter referred to as prior art 1. The wavelength filter of prior art 1 is an optical device that includes dielectric multi-layer filters. To achieve a higher wavelength selectivity, it is necessary to employ a large number of layers in the wavelength filter. To do so, however, high production costs are required.

Also, the wavelength filter of prior art 1 has a fixed reflection wavelength range. To vary the reflection wavelength range, the rotation with respect to the optical axis of the wavelength filter needs to be varied using a mechanical structure. Therefore, the optical axis of the light incident on the wavelength filter needs to be varied using a mechanical structure.

Furthermore, the wavelength filter of prior art 1 is a transmission-type optical device. To apply this wavelength filter to optical communications, it is necessary to physically cut the optical waveguide path, which is the transmitting part, as shown in FIG. 2. In a case where the optical waveguide path is cut to accommodate a wavelength filter, as shown in FIG. 2, the light transmission loss becomes greater. To reduce the light transmission loss, the wavelength filter should be formed by a reflection optical device that reflects a specific wavelength in narrow bands. However, this method has not been established in the prior art.

Magnusson, et al. have disclosed reflection wavelength filters each having a minute lattice structure on a plane perpendicularly crossing the optical axis so as to cause reflections in narrow wavelength bands (Applied Physics Letters, Vol. 61, pp. 1022-1024, and U.S. Pat. Nos. 5,216,680 and 5,598,300). This structure is shown in FIG. 3A, and will be hereinafter referred to as prior art 2. Also, FIG. 3B shows an example of reflection characteristics that can be typically obtained by a calculation utilizing RCWA (Rigorous Coupled-Wave Analysis) performed on the wavelength filter of prior art 2. In FIG. 3B, the ordinate axis indicates the reflection characteristics on a logarithmic scale.

As is apparent from the reflection characteristics shown in FIG. 3B, however, the reflection wavelength filter of prior art 2 has a problem that a large enough reflection to cover a desired frequency band fb cannot be secured, because the reflectivity greatly decreases with a small change in the wavelength. For this reason, it has been difficult to employ the wavelength filter of prior art 2 for communications.

### SUMMARY OF THE INVENTION

It is therefore an object of the present invention to provide a wavelength filter and an optical device including the wavelength filter in which the above disadvantage is eliminated.

A more specific object of the present invention is to provide a wavelength filter that reflects light in a frequency band that is wide enough for communications, and an optical device that includes the wavelength filter.

Another specific object of the present invention is to provide a variable wavelength filter that reflects light in a frequency band wide enough for communications and has variable wavelength selectivity, and an optical device that includes the variable wavelength filter.

Yet another specific object of the present invention is to provide an optical device that can attenuates reflectivity outside a desired frequency band for the use of communications.

The above objects of the present invention are achieved by a wavelength filter comprising a plurality of lattice structures that are arranged at predetermined intervals in the direction of an optical axis, each of the lattice structures having regions of two different refractive indices that are alternately arranged.

The above objects of the present invention are also achieved by a variable wavelength filter comprising a plurality of lattice structures that are arranged at predetermined intervals in the direction of an optical axis, each of the lattice structures having regions of two different substances that are alternately arranged, and at least one of the substances being an electrooptical material.

The above objects of the present invention are also achieved by an optical device comprising one or more wavelength filters that are formed on a single substrate, each of the wavelength filters including a plurality of lattice structures that are arranged at predetermined intervals in the direction of an optical axis, and each of the lattice structures having regions of two different refractive indices that are alternately arranged.

The above objects of the present invention are also achieved by an optical device comprising one or more variable wavelength filters that are formed on a single substrate, each of the variable wavelength filters including a plurality of lattice structures that are arranged at predetermined intervals in the direction of an optical axis, each of the lattice structures having regions of two different substances that are alternately arranged, and at least one of the substances being an electrooptical material.

### BRIEF DESCRIPTION OF THE DRAWINGS

Other objects, features and advantages of the present invention will become more apparent from the following detailed description when read in conjunction with the accompanying drawings, in which:

FIGS. 1A through 1D illustrate the structure and characteristics of a wavelength filter in accordance with prior art 1;

FIG. 2 illustrates the structure of an optical device that includes the wavelength filter in accordance with prior art 1;

FIG. 3A illustrates the structure of a wavelength filter in accordance with prior art 2;

FIG. 3B is a graph showing an example of reflection characteristics that can be typically obtained by a calculation utilizing RCWA performed on the wavelength filter shown in FIG. 3A;

FIG. 4 schematically illustrates the structure of a wavelength filter in accordance with a first embodiment of the present invention;

FIG. 5A illustrates the structure of a specific example of the wavelength filter in accordance with the first embodiment;

FIG. 5B is a graph showing an example of reflection characteristics that can be typically obtained by a calculation utilizing RCWA performed on the wavelength filter of FIG. 5A;

FIG. 6 illustrates an example structure of a wavelength filter device that employs the wavelength filter of FIG. 5A;

FIGS. 7A through 7E illustrate the first half of a production process of the wavelength filter device of FIG. 6;

FIGS. 8A through 8E illustrate the second half of the production process of the wavelength filter device of FIG. 6;

FIG. 9A illustrates the structure of a wavelength filter in accordance with a second embodiment of the present invention;

FIG. 9B is a graph showing an example of reflection characteristics that can be typically obtained by a calculation utilizing RCWA performed on the wavelength filter of FIG. 9A;

FIG. 10 illustrates an example structure of a wavelength filter device in accordance with a third embodiment of the present invention;

FIG. 11 is a graph showing an example of reflection characteristics that can be typically obtained by a calculation utilizing RCWA performed on the wavelength filter device of FIG. 10;

FIG. 12 illustrates an example structure of a wavelength filter device in accordance with a fourth embodiment of the present invention;

FIG. 13 is a graph showing an example of reflection characteristics that can be typically obtained by a calculation utilizing RCWA performed on the wavelength filter device of FIG. 12;

FIG. 14 illustrates the structure of a variable wavelength filter in accordance with a fifth embodiment of the present invention;

FIG. 15 illustrates an example structure of a variable wavelength filter device in accordance with a sixth embodiment of the present invention;

FIG. 16 illustrates the structure of a variable wavelength filter in accordance with a seventh embodiment of the present invention; and

FIG. 17 illustrates the structure of a variable wavelength filter device in accordance with an eighth embodiment of the present invention.

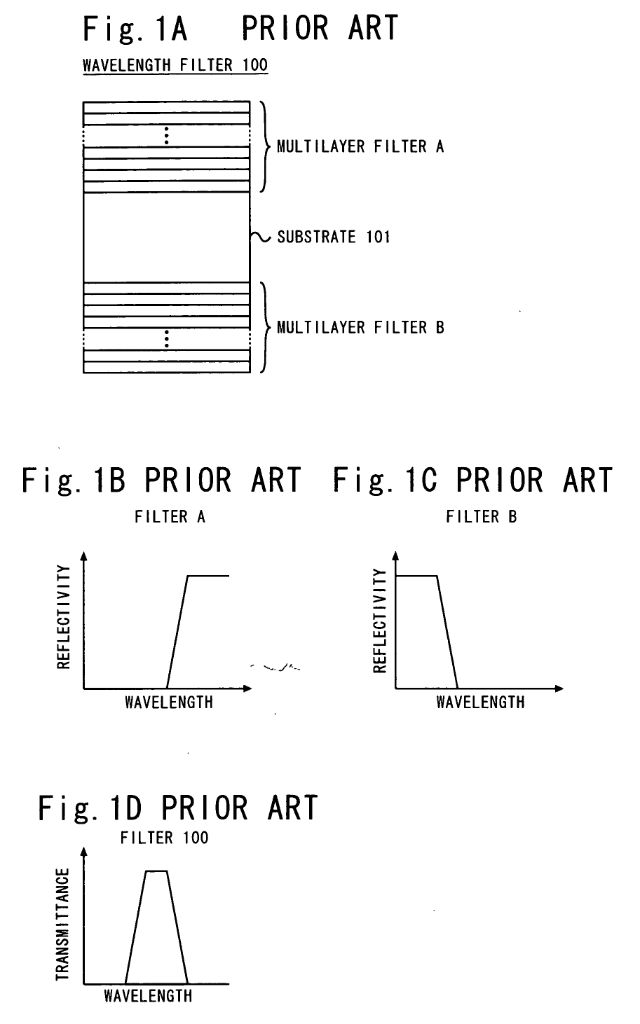

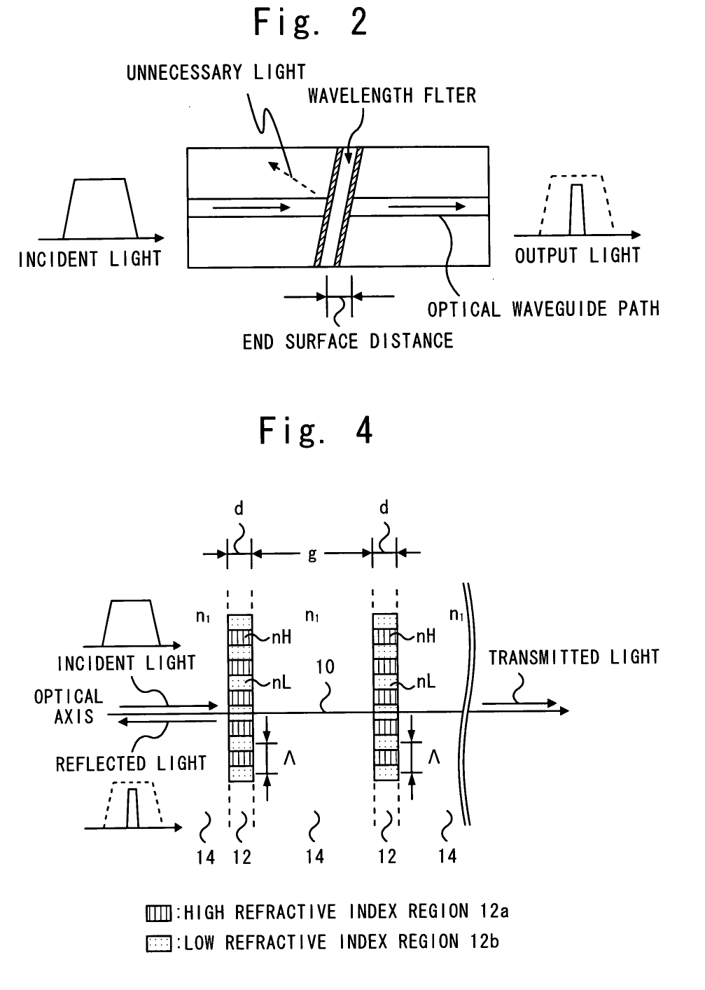

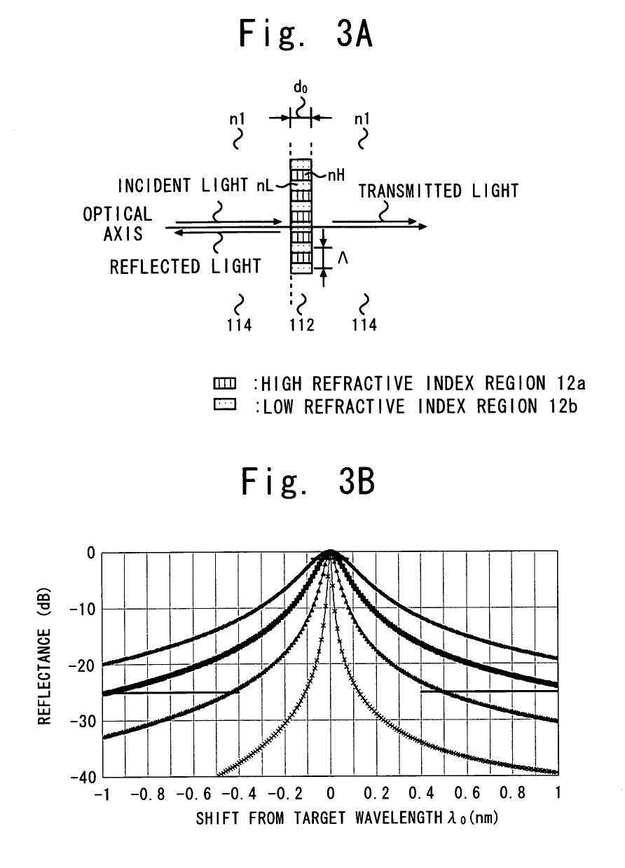

### DESCRIPTION OF THE PREFERRED EMBODIMENTS

The following is a description of preferred embodiments of the present invention, with reference to the accompanying drawings.

(First Embodiment)

FIG. 4 is a schematic view of a wavelength filter in accordance with a first embodiment of the present invention. As shown in FIG. 4, the wavelength filter 1 of this embodiment includes two or more lattice filters 12 arranged at predetermined intervals in the direction of light (hereinafter referred to as the optical axis direction). The predetermined intervals may be uniform or varied.

Each of the lattice filters 12 has a lattice structure in which materials of different refractive indices (high-refractive-index regions 12a and low-refractive-index regions 12b) are alternately arranged in the direction perpendicular to the optical axis 10. In this description, nH represents the refractive index of each high-refractive-index region 12a, and nL represents the refractive index of each low-refractive-index region 12b (nL<nH).

The average value nave of the refractive indexes nH and nL of the high-refractive-index regions 12a and the low-refractive-index regions 12b is higher than the refractive index n₁ of the optical waveguide path 14, and the refractive index nL is equal to or higher than the refractive index n₁ of the optical waveguide path 14. Further, the pitch among the high-refractive-index regions 12a and the low-refractive-index regions 12b (the pitch will be hereinafter referred to as the pitch length A) is shorter than the wavelength to be reflected (this wavelength will be hereinafter referred to as the target wavelength λ₀). Here, the average refractive index nₐᵥₑ is varied with the polarization of light to be used.

Each of the lattice filters 12 has a predetermined thickness d in the direction of the optical axis. The value of the thickness d should satisfy the following equation (1) that involves the average value nₐᵥₑ of the refractive indices of the high-refractive-index regions 12a and the low-refractive-index regions 12b, and the target wavelength λ₀.

nₐᵥₑ·d=λ₀/2 (1)

Meanwhile, the value of the distance between each two lattice filters 12 arranged on the optical axis (this distances will be hereinafter referred to as the gap g) should satisfy the following equation (2).

g=g₀+N·(λ₀/n₁) (2)

wherein n₁ represents the refractive index of the material that forms the medium (the optical waveguide path 14) interposed between each two lattice filters 12, λ₀ represents the target wavelength, go represents the shortest distance among the gaps g that causes reflections in this embodiment, and N represents a positive integer. It is to be noted that the value obtained by this equation is merely used as a yardstick, and that a margin of approximately 10% is allowed in practice.

With the above-described structure, the wavelength filter 1 of this embodiment can achieve an improved wavelength selectivity. In short, the wavelength filter 1 can reflect only the neighborhood of the desired target wavelength λ₀ (i.e., filtering). Here, the optical waveguide path 14 is directly connected to the lattice filters 12, and may be formed by optical fibers, for example. In such a case, the same effects as the above can be obtained.

In the following, a more specific example of the wavelength filter 1 in accordance with this embodiment will be described. The specific example wavelength filter will be referred to as the wavelength filter 1a.

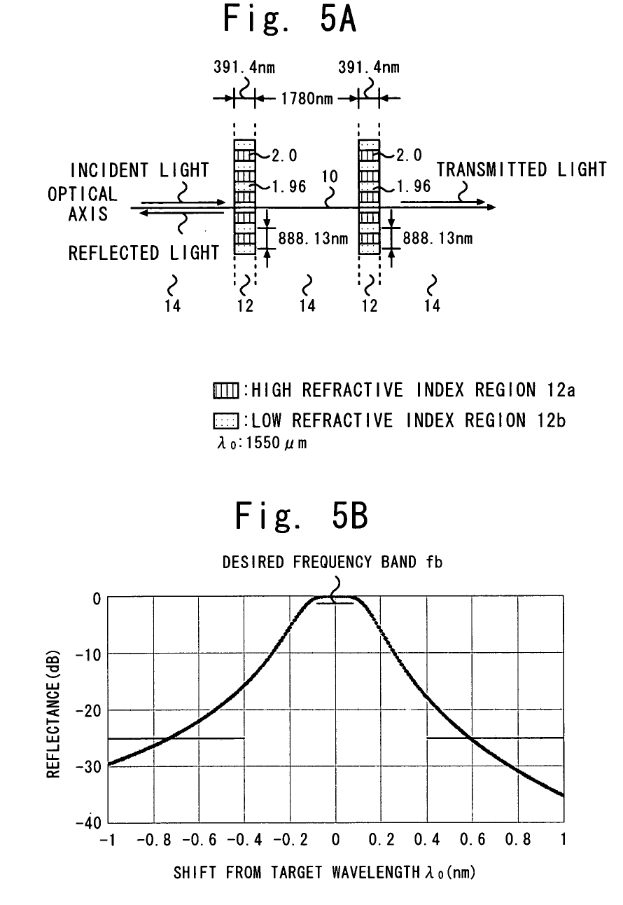

FIG. 5A is a sectional view of an example structure formed along the optical axis of the wavelength filter la having two lattice filters 12. FIG. 5B is a graph showing the reflection characteristics that were obtained by a calculation utilizing RCWA performed on the example structure shown in FIG. 5A.

In FIG. 5A, the target wavelength λ₀ is 1550 μm. The refractive index n₁ of the optical waveguide path 14 is 1.52, the refractive index nH of the high-refractive-index regions 12a is 2.0, and the refractive index nL of the low-refractive-index regions 12b is 1.96. The thickness d of each of the lattice filters 12 is 391.4 nm, the pitch length A among the high-refractive-index regions 12a and the low-refractive-index region 12b is 888.13 nm, and the gap g is 1780 nm.

As is apparent from FIG. 5B, the wavelength filter 1a exhibits improved reflection characteristics in the neighborhood of the target wavelength λ₀. In other words, this specific example realizes the reflection wavelength filter 1a that can surely reflect a desired frequency band fb having a predetermined width from the target wavelength λ₀. Here, the desired frequency band fb is a specific wavelength band normally required in optical communications.

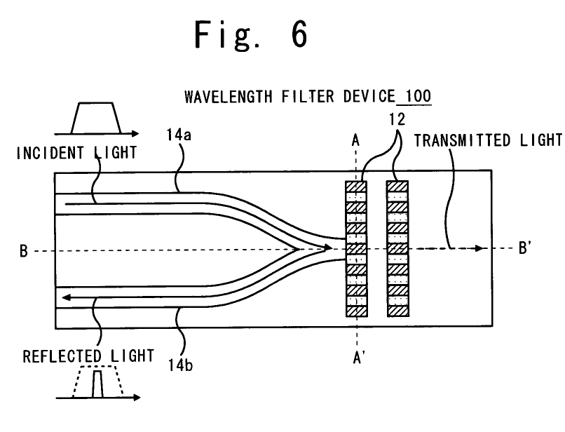

FIG. 6 illustrates an example of an optical device (a wavelength filter device 100) in which the wavelength filter 1a and the optical waveguide path 14 are formed on the same substrate. In the wavelength filter device 100 shown in FIG. 6, the incident light introduced through an optical waveguide guide path 14a is reflected according to the reflection characteristics of the wavelength filter 1a having the two lattice filters 12. The reflected light is then outputted through an optical waveguide path 14b. The transmitted light that has been transmitted through the two lattice filters 12 is either absorbed by the wavelength filter device 100 or outputted.

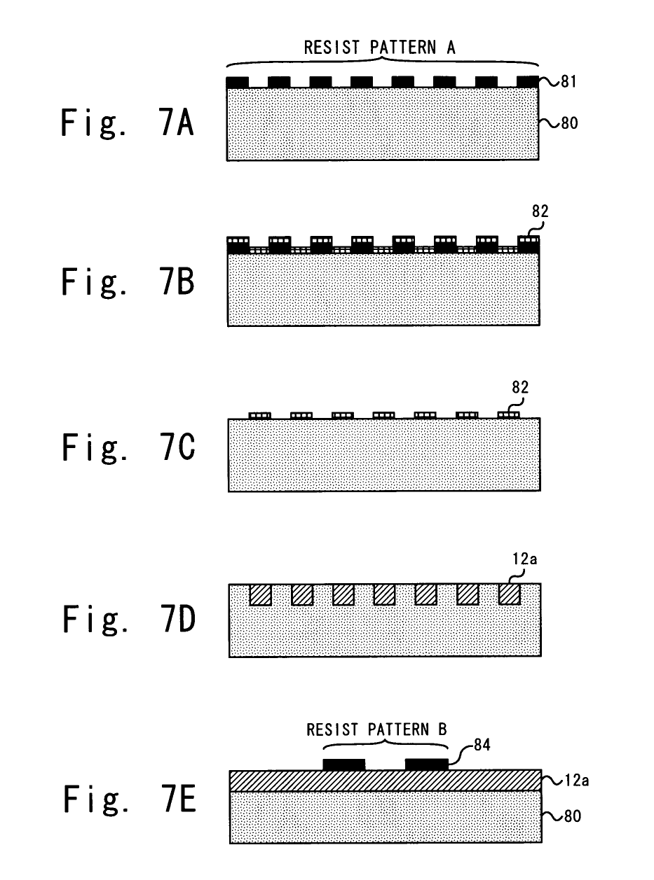

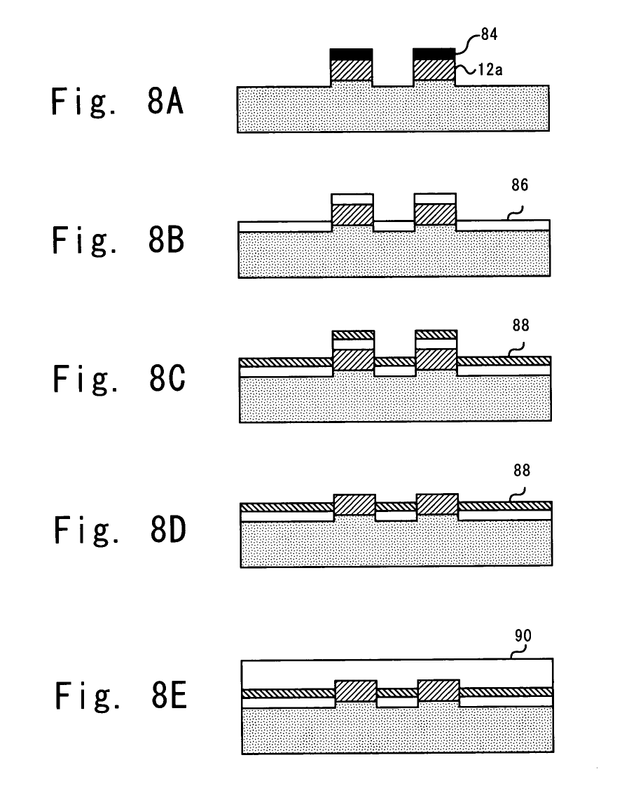

Referring now to FIGS. 7A through 7E and FIGS. 8A through 8E, the production process of the wavelength filter device 100 shown in FIG. 6 will be described in detail. FIGS. 7A through 7D are sectional views of the structure of FIG. 6, taken along the line A-A′. FIG. 7E and FIGS. 8A through 8E are sectional views of the structure of FIG. 6, taken along the line B-B′.

In this production process, a layer of resist 81 is first deposited on an LN(LiTaO₃) substrate 80, and is then exposed through a pattern for forming the high-refractive-index regions 12a, as shown in FIG. 7A. Next, Ti is vapor-deposited on the patterned surface so as to form a Ti film 82, as shown in FIG. 7B. The remaining resist 81 is then removed, and liftoff is performed on the Ti film 82 vapor-deposited on the resist 81, as shown in FIG. 7C. Annealing is then performed on the remaining parts of the Ti film 82, so as to diffuse the deposited Ti, as shown in FIG. 7D. Through these procedures, the high-refractive-index regions 12a are formed, and the pattern of the high-refractive-index regions 12a and the low-refractive-index regions 12b is established. Here, LN is the material for the low-refractive-index regions 12b, and LN diffused with Ti is the material for the high-refractive-index regions 12a.

After establishing the striped pattern, a layer of resist 84 is deposited on the surface and is then exposed through a pattern for forming the lattice filters 12, as shown in FIG. 7E. Etching is then performed, using RIE (reactive Ion Etching) or ion million, on the parts from which the resist 84 has been removed, as shown in FIG. 8A.

The remaining parts of the resist 84 are then removed, and a SiO₂ film 86 is deposited on the surface by a sputtering method or the like, as shown in FIG. 8B. Further, a SiO₂-GeO₂ film 88 is deposited on the SiO₂ film 86, as shown in FIG. 8C. After that, a resist is deposited on the surface covered with the SiO₂-GeO₂ film 88 and is exposed through a pattern for forming the optical waveguide path 14, followed by etching on the areas from which the resist has been removed, as shown in FIG. 8D. A SiO₂ film 90 is then deposited on the entire surface on which the etching has been performed, as shown in FIG. 8E. Through these procedures, the wavelength filter device 100 shown in FIG. 6 is produced. Here, SiO₂-GeO₂ is the material for the optical waveguide path 14.

In the above described manner, an optical device that includes the wavelength filter 1 of this embodiment can be produced.

(Second Embodiment)

As a second embodiment of the present invention, a case where the wavelength filter 1 of the first embodiment is formed by three lattice filters 12 will be described in detail. The wavelength filter of this embodiment will be hereinafter referred to as the wavelength filter 1b.

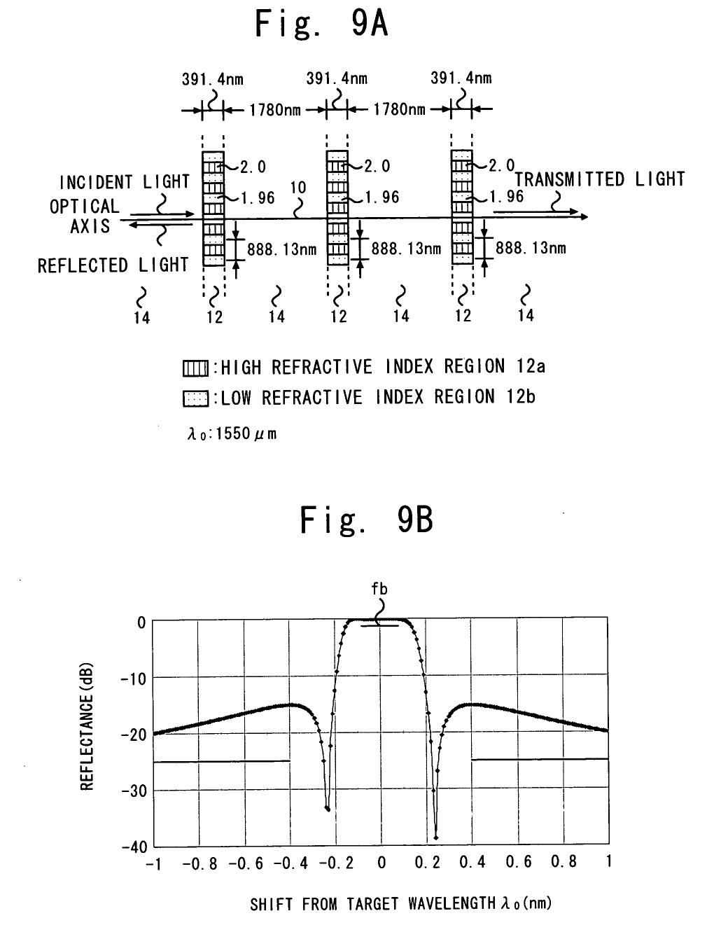

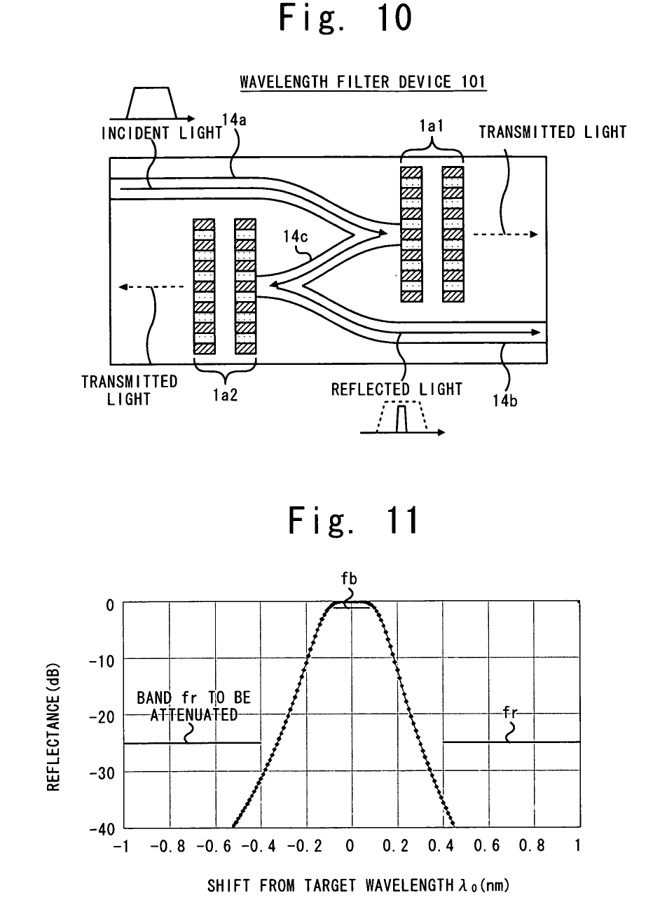

FIG. 9A is a sectional view of an example structure formed along the optical axis 10 of the wavelength filter 1b having the three lattice filters 12. FIG. 9B is a graph showing the reflection characteristics that were obtained by a calculation utilizing RCWA performed on the example structure shown in FIG. 9A.

In FIG. 9A, the target wavelength λ₀ is 1550 μm, which is the same as that in the first embodiment. The refractive index n₁ of the optical waveguide path 14 is 1.52, the refractive index nH of the high-refractive-index regions 12a is 2.0, and the refractive index nL of the low-refractive-index regions 12b is 1.96, which are also the same as those in the first embodiment. The thickness d of each of the lattice filters 12 is 391.4 nm, the pitch length A among the high-refractive-index regions 12a and the low-refractive-index regions 12b is 888.13 nm, and the gap g is 1780 nm, which are also the same as those in the first embodiment.

As shown in FIG. 9B, the three lattice filters 12 sharply emphasize the boundaries between the reflection range and the attenuation range. Accordingly, the wavelength selectivity for the desired frequency band fb can be further improved. Here, the other parts of the structure of this embodiment are the same as those of the first embodiment, and therefore, explanation of them is omitted in this description.

(Third Embodiment)

Although the optical device (the wavelength filter device 100) of the first embodiment includes only one wavelength filter 1a, two or more wavelength filters may be employed in an optical device. In the following, a case where two wavelength filters are employed will be described as a third embodiment of the present invention.

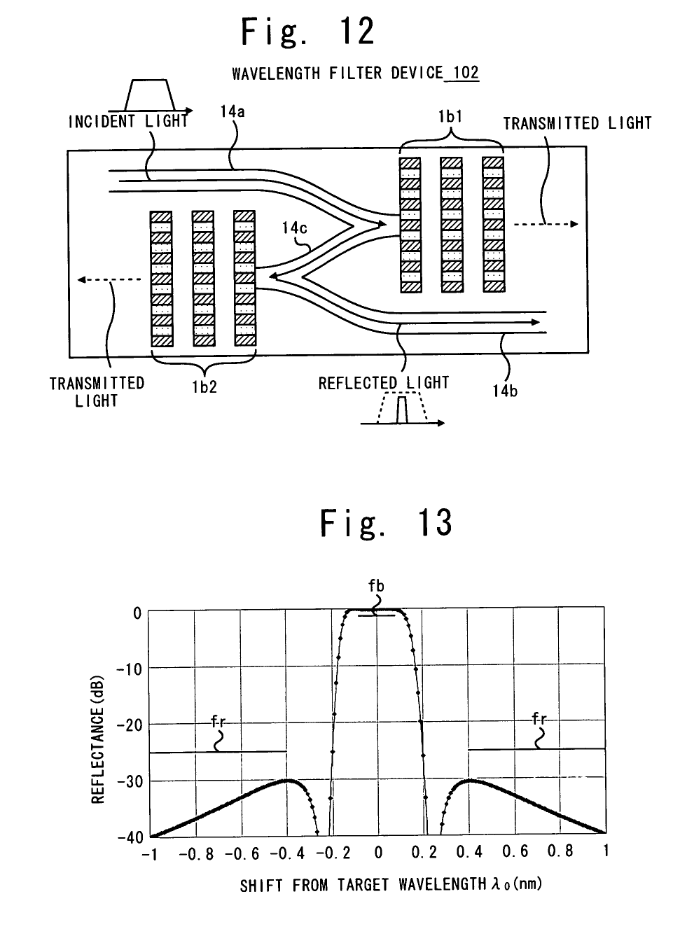

FIG. 10 illustrates a wavelength filter device 101 in accordance with this embodiment. In the wavelength filter device 101, the incident light introduced through an optical waveguide path 14a is reflected into an optical waveguide path 14c, according to the reflection characteristics of a first-stage wavelength filter 1a1. This wavelength filter 1a1 includes the two lattice filters 2 of the first embodiment. The transmitted light that has been transmitted through the first-stage wavelength filter 1a1 is either absorbed by the wavelength filter device 101 or outputted.

The light reflected into the optical waveguide path 14c is next reflected according to the reflection characteristics of a second-stage wavelength filter 1a2. The reflected light is then outputted through an optical waveguide path 14b. The wavelength filter 1a2 includes the two lattice filters 12 of the first embodiment. The transmitted light that has been transmitted through the second-stage wavelength filter 1a2 is either absorbed by the wavelength filter device 101 or outputted.

FIG. 11 is a graph showing the reflection characteristics obtained by a calculation utilizing RCWA performed on the wavelength filter device 101 of this embodiment. As is apparent from FIG. 11, two or more wavelength filters 1a are employed to sharply emphasize the boundaries between the reflection range and the attenuation range. Also, the wavelengths outside the reflection range are further attenuated, so that the wavelength selectivity for the desired frequency band fb is improved, and that the attenuation rate in the frequency band to be attenuated is increased. Accordingly, the specific wavelength band normally required in optical communications is surely reflected, and the unnecessary frequency bands can be sufficiently attenuated. The other parts of the structure of this embodiment are the same as those of the first embodiment, and therefore, explanation of them is omitted in this description.

(Fourth Embodiment) The wavelength filters 1a1 and 1a2 employed in the third embodiment may be replaced with wavelength filters 1b1 and 1b2 each including the three lattice filters 12 of the second embodiment. In the following, such a structure will be described as a fourth embodiment of the present invention.

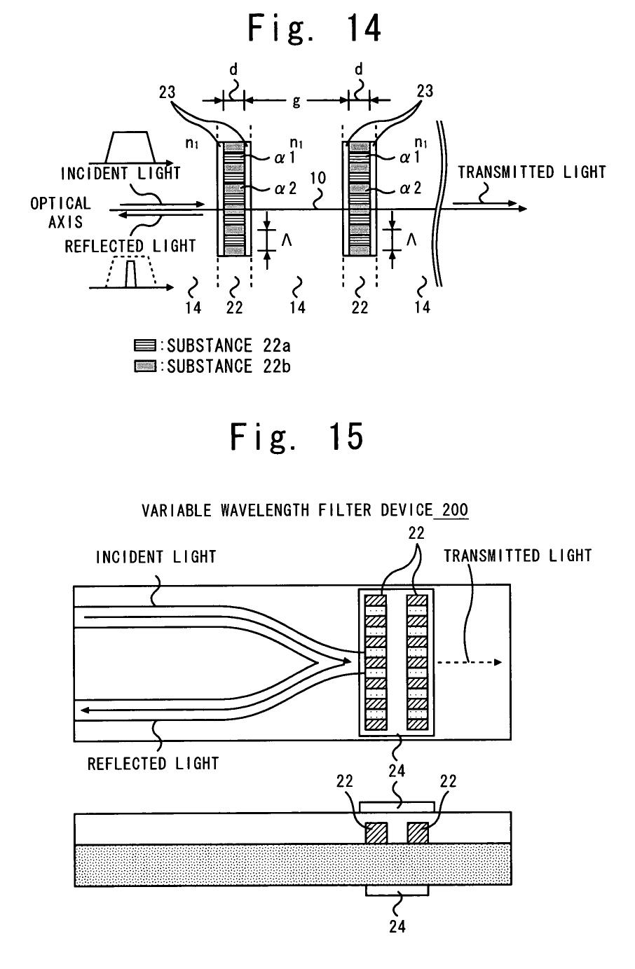

FIG. 12 illustrates a wavelength filter device 102 of this embodiment. In the wavelength filter device 102, the incident light introduced through the optical waveguide path 14a is first reflected into the optical waveguide path 14c, according to the reflection characteristics of the first-stage wavelength filter 1b1. The wavelength filter 1b1 includes the three lattice filters 12 of the second embodiment. The transmitted light that has been transmitted through the first-stage wavelength filter 1b1 is either absorbed by the wavelength filter device 102 or outputted.

The light reflected into the optical waveguide path 14c is next reflected according to the reflection characteristics of the second-stage wavelength filter 1b2. The reflected light is then transferred through the optical waveguide path 14b and outputted to the outside. The wavelength filter 1b2 includes the three lattice filters 12 of the second embodiment. The transmitted light that has been transmitted through the second-stage wavelength filter 1b2 is either absorbed by the wavelength filter device 102 or outputted.

FIG. 13 is a graph showing the reflection characteristics obtained by a calculation utilizing RCWA performed on the wavelength filter device 102 of this embodiment. As can be seen from FIG. 13, the two wavelength filters 1b1 and 1b2 sharply emphasize the boundaries between the reflection range and the attenuation range. Also, the wavelengths outside the reflection range are further attenuated, so that the wavelength selectivity for the desired frequency band fb is improved, and that the attenuation rate in the frequency band to be attenuated is increased. Accordingly, the specific wavelength band normally required in optical communications is surely reflected, and the unnecessary frequency bands can be sufficiently attenuated. The other parts of the structure of this embodiment are the same as those of the first embodiment, and therefore, explanation of them is omitted in this description.

(Fifth Embodiment)

The lattice filters 12 of each of the foregoing embodiments may be made of a material having an electrooptical effect, to thereby form a variable wavelength filter 2. In the following, this structure will be described as a fifth embodiment of the present invention.

FIG. 14 illustrates the structure of the variable wavelength filter 2 of this embodiment. In this embodiment, the variable wavelength filter 2 includes two lattice filters 22. However, the number of lattice filters 12 is not limited to two, but may be three or greater.

As can be seen from FIG. 14, each of the lattice filters 22 has substances 22a and 22b alternately arranged in the direction perpendicular to the optical axis 10. In this embodiment, al represents the electrooptical constant of the substances 22a, and α2 represents the electrooptical constant of the substances 22b.

Examples of the materials for the substances 22a and 22b include LN(LiNbO₃), LT(LiTaO₃), PZT(Pb(Zr, Ti)O₃), and PLZT((Pb, La) (Zr, Ti)O₃).

Each of the lattice filters 22 also has electrodes 23 for inducing an electric field. In this embodiment, the electrodes 23 are provided on the surfaces that reflect light and on the surfaces that transmit light. With this structure, an electric field can be induced in the lattice filters 22 made of a material having an electrooptical effect. In this case, each of the electrodes 23 is made of a material that is transparent to the target wavelength λ₀, such as ITO (indium-tin oxide).

With the above structure, this embodiment achieves the same effects as each of the foregoing embodiments, and realizes the variable wavelength filter 2 that can vary the wavelength to be reflected according to the voltage to be applied to the electrodes 23. Accordingly, the wavelength selectivity can be diversified. The other parts of the structure of this embodiment are the same as those of the first embodiment, and therefore, explanation of them is omitted in this description.

(Sixth Embodiment)

Each of the electrodes 23 can have a different structure from that of the fifth embodiment. In the following, such a case will be described as a sixth embodiment of the present invention.

FIG. 15 illustrates an example of an optical device (a variable wavelength filter 200) using the variable wavelength filter 2. As can be seen from FIG. 15, electrodes 24 are formed on planes that do not cross the optical axis 10, and are common to the two lattice filters 22. With this structure, an electric field can be induced in the lattice filters 22 made of a material having an electrooptical effect. In this embodiment, the optical waveguide path 14 is directly connected to the lattice filters 22.

In the example shown in FIG. 15, one of the two electrodes 24 is provided on the back face of the LN substrate, opposite from the lattice filters 22. However, the arrangement of the electrodes 24 is not limited to this, but may be varied in many ways, as long as the two electrodes 24 can induce an electric field in the lattice filters 22.

With the above structure, this embodiment can achieve the same effects as those of the fifth embodiment. Also, as the electrodes 24 are common to the two lattice filters 22, the production process can be simplified. The other parts of the structure of this embodiment are the same as those of the first embodiment, and therefore, explanation of them is omitted in this description.

(Seventh Embodiment)

Although the substances 22a and 22b are both made of a material having an electrooptical effect in the fifth embodiment, it is also possible to form only the substances 22a or the substances 22b with a material having an electrooptical effect. In the following, such a case will be described as a seventh embodiment of the present invention.

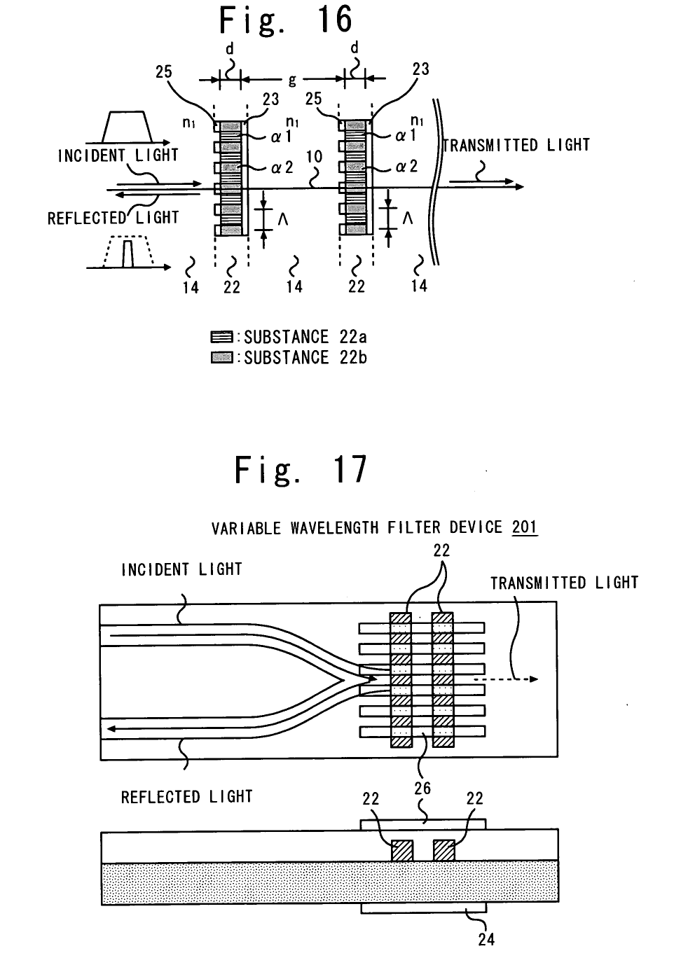

FIG. 16 illustrates the structure of a variable wavelength filter 2a of this embodiment. As can be seen from FIG. 16, electrodes 25 for inducing an electric field in the substances having electrooptical effects are provided only on the light reflection sides of the substances 22b. Like the electrodes 23, the electrodes 25 are also made of a material that is transparent to the target wavelength λ₀.

With the above structure, this embodiment can provide a variable wavelength filter that avoids inducing an electric field in unnecessary substances. Accordingly, the wavelength selectivity can be further diversified. The other parts of the structure of this embodiment are the same as those of the first embodiment, and therefore, explanation of them is omitted in this description.

(Eighth Embodiment)

An eighth embodiment of the present invention is to provide a structure in which a electrode 26 for inducing an electric field in either the substances 22a or 22b is provided for both of the two lattice filters 22, as shown in FIG. 17.

With this structure, this embodiment can provide a variable wavelength filter that avoids inducing an electric field in unnecessary substances. Also, as the electrodes 24 and 26 are common to the two lattice filters 22, the production process can be simplified. The other parts of the structure of this embodiment are the same as those of the first embodiment, and therefore, explanation of them is omitted in this description.

The present invention is not limited to the specifically disclosed embodiments, and other embodiments, variations and modifications may be made without departing from the scope of the present invention.

The present application is based on Japanese Patent Application No. 2002-215263 filed on Jul. 24, 2002, the entire disclosure of which is hereby incorporated by reference.

What is claimed is:

1. A wavelength filter comprising
a plurality of lattice structures that are arranged at predetermined intervals in the direction of an optical axis,
each of the lattice structures having regions of two different refractive indices that are alternately arranged.

2. The wavelength filter as claimed in claim 1, wherein the average refractive index of the lattice structures is higher than the refractive index of areas for transmitting light before and behind the lattice structures.

3. The wavelength filter as claimed in claim 1, wherein the regions of two different refractive indices are alternately arranged in a direction perpendicular to the optical axis.

4. The wavelength filter as claimed in claim 1, wherein the predetermined intervals are uniform.

5. The wavelength filter as claimed in claim 1, wherein the lattice structures are formed on a substrate on which an optical waveguide path is also formed.

6. The wavelength filter as claimed in claim 1, wherein the optical waveguide path is directly connected to the lattice structures.

7. The wavelength filter as claimed in claim 1, wherein the optical waveguide path includes optical fibers.

8. The wavelength filter as claimed in claim 1, comprising two or three of the lattice structures.

9. A variable wavelength filter comprising
a plurality of lattice structures that are arranged at predetermined intervals in the direction of an optical axis,
each of the lattice structures having regions of two different substances that are alternately arranged, and
at least one of the substances being an electrooptical material.

10. The variable wavelength filter as claimed in claim 9, further comprising electrodes for inducing an electric field in the lattice structures.

11. The variable wavelength filter as claimed in claim 9, wherein the average refractive index of the lattice structures is higher than the refractive index of areas for transmitting light before and behind the lattice structures.

12. The variable wavelength filter as claimed in claim 9, wherein the regions of two different substances are alternately arranged in a direction perpendicular to the optical axis.

13. The variable wavelength filter as claimed in claim 9, wherein the predetermined intervals are uniform.

14. The variable wavelength filter as claimed in claim 9, wherein the lattice structures are formed on a substrate on which an optical waveguide path is also formed.

15. The variable wavelength filter as claimed in claim 9, wherein the optical waveguide path is directly connected to the lattice structures.

16. The variable wavelength filter as claimed in claim 9, wherein the electrooptical material includes at least one of LiNbO₃, LiTaO₃, Pb(Zr, Ti)O₃, and (Pb, La)(Zr, Ti)O₃.

17. The variable wavelength filter as claimed in claim 10, wherein the electrodes are formed on at least either the light reflection faces or the light transmission faces of the lattice structures.

18. The variable wavelength filter as claimed in claim 17, wherein the electrodes are transparent electrodes.

19. The variable wavelength filter as claimed in claim 10, wherein the electrodes are common to two or more of the lattice structures.

20. An optical device comprising
one or more wavelength filters that are formed on a single substrate,
each of the wavelength filters including a plurality of lattice structures that are arranged at predetermined intervals in the direction of an optical axis, and
each of the lattice structures having regions of two different refractive indices that are alternately arranged.

21. An optical device comprising
one or more variable wavelength filters that are formed on a single substrate,
each of the variable wavelength filters including a plurality of lattice structures that are arranged at predetermined intervals in the direction of an optical axis,
each of the lattice structures having regions of two different substances that are alternately arranged, and
at least one of the substances being an electrooptical material.

22. An optical device comprising
two or more wavelength filters that are formed on a single substrate,
each of the wavelength filters including a plurality of lattice structures that are arranged at predetermined intervals in the direction of an optical axis,
each of the lattice structures having regions of two different refractive indices that are alternately arranged, and
the distance between the wavelength filters being longer than each of the predetermined intervals.

23. An optical device comprising
two or more variable wavelength filters that are formed on a single substrate,
each of the variable wavelength filters including a plurality of lattice structures that are arranged at predetermined intervals in the direction of an optical axis,
each of the lattice structures having regions of two different substances that are alternately arranged,
at least one of the substances being an electrooptical material, and
the distance between the variable wavelength filters being longer than each of the predetermined intervals.
